(19) United States
(12) Patent Application Publication
(10) Pub. No.: US 2005/0162690 A1
(43) Pub. Date: Jul. 28, 2005

(54) Network system for commonly using local printer and method thereof

(75) Inventor: Yong-In Eom, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/038,158

(22) Filed: Jan. 21, 2005

(30) Foreign Application Priority Data
Jan. 28, 2004 (KR) 2004-5322

(51) Int. Cl. G06F 15/00

(52) U.S. Cl. 358/1.15

(57) ABSTRACT

Disclosed is a printing apparatus and method in a terminal device constituting a network system which can share a local printer installed in another terminal device. The printing method includes the steps of determining whether an installed printer can be used if a print command is inputted, searching for another terminal device connected to a usable printer among the terminal devices connected through the network if the printer is in an unusable state, transmitting print data to the searched terminal device, and printing the print data using the second printer installed in the other terminal device.

### CROSS-REFERENCE TO RELATED APPLICATION

This application claims the benefit under 35 U.S.C. §119(a) of Korean Patent Application No. 2004-5322, filed on Jan. 28, 2004, the entire disclosure of which is hereby incorporated by reference.

### BACKGROUND OF THE INVENTION

1. Field of the Invention

The present invention relates to a network terminal device and a method of using printers connected to another network terminal device. More particularly, the present invention relates to a network terminal device and a method thereof which can perform a printing job using a local printer connected to another terminal device in a network system having a plurality of terminal devices.

2. Description of the Related Art

Personal computers (PC) have become so common that the age of “one man, one PC” has essentially arrived. Even in the home, not only in the office, two or more computers are commonly installed and used. In this case, the home computers may be connected together through a network using network equipment for the sake of convenience.

Meanwhile, with the increased use of computers, peripheral devices for the diverse uses of computers have also become increasingly more common. A representative example of such a peripheral device may be a printer. For several years now, printers have found their way into many homes, and recently, low-priced color printers and network printers have also been developed and used.

FIG. 1 is a flowchart illustrating a printing method in a conventional PC having a local printer installed thereon. Referring to FIG. 1, if a user inputs a print command after he or she prepares a document to be printed using a specified application program (step S10), a printer driver recognizes a presently installed printer and then converts the document into data that can be recognized by the printer.

The converted data is transmitted to the installed printer through an input/output interface (step S20). If such print data and print command are received from the user's PC, a control unit part of the printer determines whether the printer is in a printable state by checking if printing papers and toner have been supplied or if the replacement time of each constituent unit of the printer elapses using various kinds of sensors (step S30).

If the printer is in a usable state, the control unit part of the printer performs a printing operation (step S40), while if the printer is not in a usable state, the control unit part displays an error message through a specified display screen (step S50).

The conventional printing system as described above, however, has the problems in that if there is no printer installed in the user's PC or if the printer is in an unusable state, the printing system cannot perform the printing operation unless a usable printer is newly installed or the printer becomes usable.

Also, if the printer connected to the user's PC is in the unusable state even in a state that several computers are connected through a network and plural local printers are connected to the computers, it becomes necessary for the user to make the PC transmit the print data to another PC in which another usable printer is installed, to make the corresponding PC execute the application program, and then to input the print command to the corresponding PC again.

Accordingly, the need exists for a printing system and method that allows a personal computer connected to a network to easily share a printer.

### SUMMARY OF THE INVENTION

The present invention has been developed in order to solve the above drawbacks and other problems associated with the conventional arrangement. An aspect of the present invention is to provide a printing system and a method thereof which can share a local printer that is installed in a PC connected to a network system.

The foregoing and other objects and advantages are substantially realized by providing a printing method in a network system in which a plurality of terminal devices are connected through a network, according to embodiments of the present invention, which comprises the steps of (a) a first terminal device among the plurality of terminal devices judging whether a first printer installed in the first terminal device itself can be used if a print command is inputted thereto, (b) searching for a second terminal device connected to a second printer that can be used among the terminal devices connected through the network if the first printer is in an unusable state, (c) transmitting print data to the second terminal device, and (d) the second terminal device printing the print data using the second printer.

It is preferable that the printing method further comprises the step of the first terminal device judging that the first printer is in an unusable state even if the first printer is not installed in the first terminal device or if the first printer is not normally installed in the first terminal.

More preferably, the printing method further comprises the step of the first terminal device displaying a specified error message if the first terminal device judges that the first printer is in the unusable state. Accordingly, a user can select a mode in which a printer installed in another terminal device in the network can be shared.

According to an embodiment of the present invention, step (b) may comprise the steps of the first terminal device transmitting a specified search signal to the respective terminal devices connected to the first terminal device through the network, at least one terminal device connected to the usable printer among the terminal devices that have received the search signal transmitting a specified response signal to the first terminal device, and the first terminal device displaying a list of the terminal devices that have transmitted the response signal.

In another embodiment of the present invention, step (b) may comprise the steps of the first terminal device transmitting a specified search signal to the respective terminal devices connected to the first terminal device through the network, the respective terminal devices transmitting printer information in response to the search signal, and the first terminal device searching for at least one terminal device connected to a usable printer by confirming the printer information and displaying a list of the searched terminal devices.

In the embodiments of the present invention, step (c) may comprise the steps of selecting the second terminal device on the list and transmitting the print data to the second terminal device, so that if several usable printers exist, the user can select one of the usable printers as needed.

In another aspect of the present invention, there is provided a network terminal device connected to at least another terminal device through a network, which comprises a data transmitting/receiving unit for transmitting and receiving a specified data signal to and from the respective terminal devices connected through the network, a control unit for judging whether a printer installed in the terminal device is usable or unusable, and if the printer is unprintable, searching for other terminal devices connected to usable printers, and a display unit for displaying a list of the terminal devices connected to the usable printers, wherein the control unit performs a printing operation using the printer installed in the terminal device selected on the list.

In this case, if specified response signals are received from the terminal devices connected to the usable printers after specified search signals are transmitted to the respective terminal devices connected through the network, the control unit can prepare a list of the terminal devices that have transmitted the response signals and display the list through the display unit.

It is preferable that if a specified terminal device is selected on the list, the data transmitting/receiving unit transmits the print data to the selected terminal device.

In still another aspect of the present invention, there is provided a network system having at least two network terminal devices as described above, which comprises a first terminal device for searching for a terminal device connected to a usable printer among other terminal devices connected through a network and transmitting print data to the searched terminal device if a printer installed in the first terminal device is unusable, and a second terminal device for performing a printing operation using the installed printer if the print data is received from the first terminal device.

In this case, the first terminal device may comprise a data transmitting/receiving unit for transmitting and receiving a specified data signal to and from the respective terminal devices connected through the network, a control unit for searching for other terminal devices connected to usable printers among the respective terminal devices if the printer is unprintable, and a display unit for displaying a list of the terminal devices connected to the usable printers. The second terminal device may comprise a storage unit for storing the print data transmitted from the first terminal device.

Preferably, if specified response signals are received from the terminal devices connected to the usable printers after specified search signals are transmitted to the other terminal devices, the control unit of the first terminal device may prepare a list of the terminal devices that have transmitted the response signals and display the list through the display unit. If the second terminal device is selected on the list, the data transmitting/receiving unit can transmit the print data to the second terminal device.

### BRIEF DESCRIPTION OF THE DRAWINGS

The above aspects and features of the present invention will be more apparent by describing certain embodiments of the present invention with reference to the accompanying drawings, in which:

FIG. 1 is a flowchart illustrating a printing method in a conventional terminal device;

FIG. 2 is a view illustrating a network environment comprising network terminal devices according to an embodiment of the present invention;

FIG. 3 is a block diagram illustrating the construction of a network terminal device according to an embodiment of the present invention;

FIG. 4 is a flowchart illustrating a printing method in a network terminal device according to an embodiment of the present invention; and

FIG. 5 is a flowchart illustrating a method of sharing a local printer in a network environment according to an embodiment of the present invention.

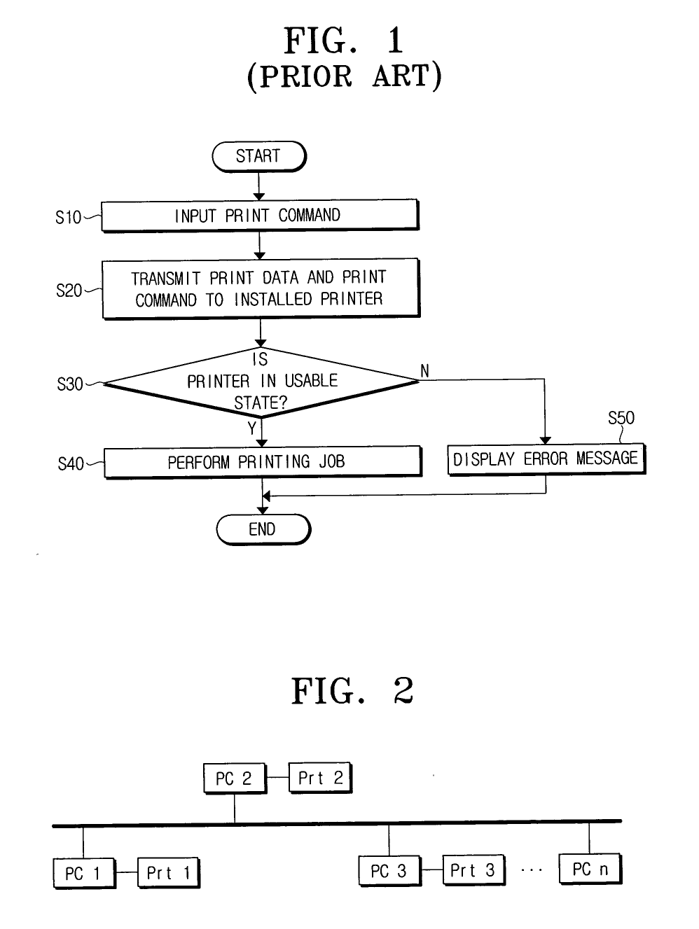

In the following description, it should be understood that the same drawing reference numerals are used for the same elements, features and structures even in different drawings.

### DETAILED DESCRIPTION OF EXEMPLARY EMBODIMENTS

Certain embodiments of the present invention will be described in greater detail with reference to the accompanying drawings.

The matters defined in the following description such as a detailed construction and elements are provided to assist in a comprehensive understanding of the invention. Those of ordinary skill in the art will appreciate that various changes and modifications can be made to the embodiments described herein without departing form the spirit and scope of the invention. Also, descriptions of well-known functions or constructions are omitted for the sake of clarity.

FIG. 2 is a view illustrating a network environment comprising network terminal devices according to an embodiment of the present invention. Referring to FIG. 2, PC1 to PCn are connected through a network. Some PCs may be provided with local printers Prt1, Prt2 and Prt3 and other PCs may be provided with no local printer.

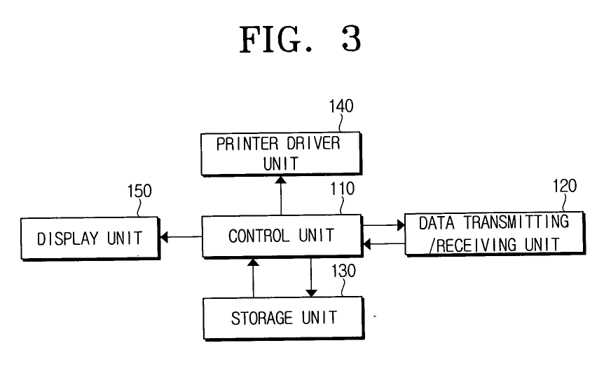

FIG. 3 is a block diagram illustrating the construction of a network terminal device PC1 constituting the network of FIG. 2. This terminal device PC1 is provided with a printer Prt1.

Referring to FIG. 3, the terminal device PC1 may comprise a control unit 110, a data transmitting/receiving unit 120, a storage unit 130, a printer driver unit 140 and a display unit 150.

The printer driver unit 140 serves to make the terminal device PC1 recognize and communicate with the printer Prt1, and converts commands of a general operating system into special commands that can be recognized by the printer Prt1. If a user inputs a print command after he/she prepares a document to be printer using a specified application program, the printer driver unit 140 converts the document into print data that can be recognized by the printer Prt1.

Meanwhile, if the user's print command is received, the control unit 110 controls the printer driver unit 140 to converts the document into the print data, and confirms whether the currently installed printer Prt1 is in a usable state. That is, the control unit 110 confirms if printing paper is available, if the amount of toner is sufficient, and the like.

If the printer is in an unusable state as a result of confirmation, the control unit 110 controls the display unit 150 to display a specified error message. Meanwhile, if the printer Prt1 is not installed or if the printer Prt1 is not normally installed (for example, if the power is off), the control unit 110 may judge that the printer is in the unusable state.

If the user confirms the error message, he/she may search whether there is a usable printer from among the printers installed in the other terminal devices PC2 to PCn on the network by inputting a search command for searching whether any other printable printer exists.

In this case, the control unit 110 may search the other terminal devices connected to usable printers.

In one embodiment of the present invention, the control unit 110 performs a search such that it transmits a search signal comprising information about printers that can be connected to the terminal device PC1 to other terminal devices PC2 to PCn, and receives specified response signals from the terminal devices connected to the printers that coincide with the printer information included in the search signal.

In another embodiment of the present invention, the control unit 110 transmits the search command to all the terminal devices on the network by controlling the data transmitting/receiving unit 120 if the user inputs the search command. If the respective terminal devices transmit information about the printers installed in themselves to the control unit 110 in response to the search command, the control unit 110 judges whether the printers are usable to the terminal device PC 1 by confirming the transmitted printer information. In this case, the control unit 110 of the terminal device PC1 judges whether the printers are usable by confirming a device ID, a printer driver name, an MDL, and the like, among the transmitted information.

If the terminal devices connected to the usable printers are found, the control unit 110 prepares a list of the found terminal devices and controls the display unit 150 to display the prepared list. Accordingly, the user can select any nearby terminal device and performs a printing work using the printer installed in the selected terminal device.

Unlike the above-described embodiments, the user may directly connect to the respective terminal devices PC2 to PCn connected through the network and confirm whether any usable printer exists. That is, if the user selects a “network environment”, the control unit 110 controls the display unit 150 to display the list of other terminal devices connected through the network. Then, the user can select one terminal device from among the displayed terminal devices, and confirm whether the printer installed in the corresponding terminal device can be used through confirming of the information about the printer installed on the terminal device.

If the user selects the terminal device connected to the printable printer, the control unit 110 controls the data transmitting/receiving unit 120 to transmit the print data to the selected terminal device. For this, the control unit of the selected terminal device should be provided with a specified program for transmitting the received print data to the printer to print the print data.

Meanwhile, in order for the terminal device PC1 to share the printer installed therein with other terminal devices, the terminal device may further comprise a storage unit 130 for storing the print data transmitted from the terminal devices PC2 to PCn. If the print data is transmitted from another terminal device, the terminal device PC1 stores the transmitted print data in the storage unit 130, and then transmits the print data to the installed printer to print the print data even if a separate print command is not input to the terminal device PC1.

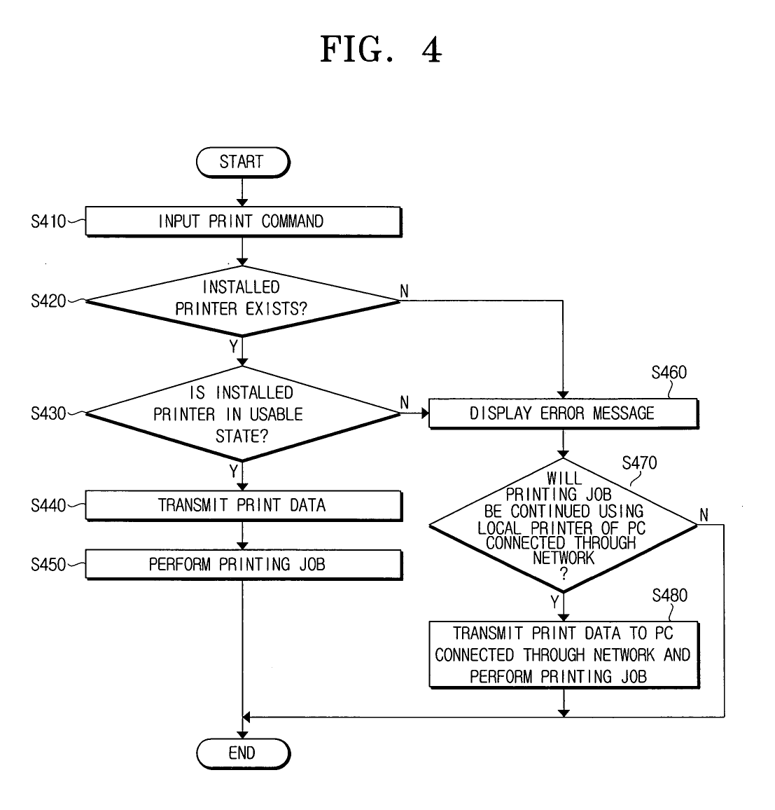

FIG. 4 is a flowchart illustrating a printing method in the network terminal device according to an embodiment of the present invention. Referring to FIG. 4, if the user inputs a print command to his/her own terminal device PC1 in order to print a specified document (step S410), the control unit 110 of the terminal device PC1 confirms whether the currently installed printer Prt1 exists (step S420).

If the installed printer Prt1 exists, the control unit 110 confirms whether the printer Prt1 is in a usable state (step S430). At this time, the control unit 110 confirms if the printing paper or toner of the printer Prt1 is insufficient or if any main component (in the case of a laser printer, photosensitive drum, various kinds of rollers, or the like) has done its time.

If the installed printer Prt1 is in a usable state, the control unit 110 transmits the print data to the installed printer Prt1 (step S440) in the same manner as the conventional printing system, and controls the printer to perform the printing work (step S450).

If the installed printer Prt1 does not exists or is in an unusable state, the control unit 110 controls the display unit 150 to display a specified error message to inform the user that the printing work cannot be performed (step S460).

Meanwhile, if the user confirms the error message, he/she may select whether to continue the printing work using another printer installed in another terminal device connected through the network (step S470). That is, an interface window, which enables the user to select a mode for sharing a local printer or to input a search command for searching for a local printer that can be shared, is displayed on the display screen simultaneously with or subsequently to the error message. If the user selects the mode for sharing the local printer, the control unit 110 searches for another terminal device connected to a usable printer on the network, and if such a terminal device exists on the network, the control unit 110 transmits the print data to the searched terminal device and performs the printing work using the printer installed in the corresponding terminal device (step S480).

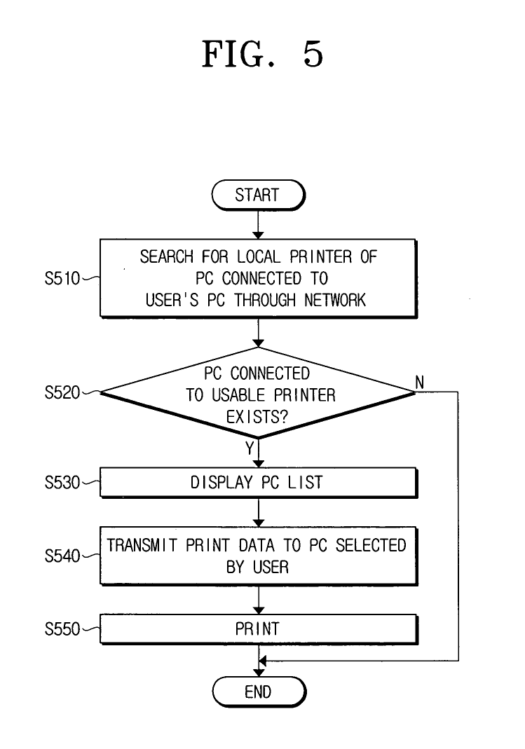

FIG. 5 is a flowchart illustrating the process performed if a mode for sharing a local printer is selected in a network environment according to an embodiment of the present invention. Referring to FIG. 5, if the user selects a mode for sharing a local printer and then selects a search command for searching a local printer that can be shared (step S510), the control unit 110 of the terminal device PC1 searches whether any terminal device connected to a usable printer among the terminal devices connected through the network exists (step S520). That is, the control unit 110 transmits a message for requesting a transmission of information about the printers installed in the respective terminal devices, and if response messages are received from the respective terminal devices, it confirms whether the printer is usable by confirming the device ID, printer driver name, MDL, or the like.

If at least one usable printer is found, the control unit 110 controls the display unit 150 to display the list of the terminal devices connected to the found printers (step S530).

If the user selects one of the terminal devices from the list, the control unit 110 of the terminal device PC1 controls the data transmitting/receiving unit 120 to transmit the print data to the selected terminal device (step S540).

If the print data is received, the selected terminal device stores the printer data in the storage unit, and then transmits the print data to the installed printer to perform the printing work (step S550).

Meanwhile, if the print data is received from the terminal device PC1 on the network, the control unit of the selected terminal device should be provided with a specified application program for transmitting the print data to the installed printer and controlling the installed printer to perform the printing work.

As described above, according to an embodiment of the present invention, the user of the respective terminal device in a network environment having several terminal devices connected through the network can share the local printer installed in another terminal device, and thus the user can perform the printing work using the shared local printer even if the local printer installed in the terminal device itself is in an unusable state, thereby alleviating the inconvenience of changing the printer or re-inputting the print command to a terminal device connected to the usable printer.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A printing method in a network system in which a plurality of terminal devices are connected through a network, the method comprising the steps of:
(a) determining by a first terminal device among the plurality of terminal devices whether a first printer installed in the first terminal device itself can be used if a print command is inputted thereto;
(b) searching for a second terminal device connected to a second printer that can be used among the terminal devices connected through the network if the first printer is in an unusable state;
(c) transmitting print data to the second terminal device; and
(d) printing from the second terminal device the print data using the second printer.

2. The printing method as claimed in claim 1, further comprising the step determing by the first terminal device that the first printer is in an unusable state even if the first printer is not installed in the first terminal device or if the first printer is not normally installed in the first terminal.

3. The printing method as claimed in claim 2, further comprising the step of displaying by the first terminal device a specified error message if the first terminal device judges that the first printer is in the unusable state.

4. The printing method as claimed in claim 1, wherein the step (b) comprises the sub-steps of:
transmitting from the first terminal device a specified search signal to the respective terminal devices connected to the first terminal device through the network;
transmitting from at least one terminal device connected to the usable printer among the terminal devices that have received the search signal a specified response signal to the first terminal device; and
displaying on the first terminal device a list of the terminal devices that have transmitted the response signal.

5. The printing method as claimed in claim 4, wherein the step (c) comprises the sub-steps of:
selecting the second terminal device on the list; and
transmitting the print data to the second terminal device.

6. The printing method as claimed in claim 1, wherein the step (b) comprises the sub-steps of:
transmitting from the first terminal device a specified search signal to the respective terminal devices connected to the first terminal device through the network;
transmitting from the respective terminal devices printer information in response to the search signal; and
confirming the printer information of the searched terminal devices by displaying a list of the searched terminal devices at the first terminal device.

7. The printing method as claimed in claim 6, wherein the step (c) comprises the sub-steps of:
selecting the second terminal device on the list; and
transmitting the print data to the second terminal device.

8. A network terminal device connected to at least another terminal device through a network, the network terminal device comprising:
a data transmitting/receiving unit for transmitting and receiving a specified data signal to and from the respective terminal devices connected through the network;
a control unit for judging whether a printer installed in the terminal device is printable or unprintable, and if the printer is unprintable, searching for other terminal devices connected to usable printers; and
a display unit for displaying a list of the terminal devices connected to the usable printers;
wherein the control unit performs a printing work using the printer installed in the terminal device selected on the list.

9. The network terminal device as claimed in claim 8, wherein if specified response signals are received from the terminal devices connected to the usable printers after specified search signals are transmitted to the respective terminal devices connected through the network, the control unit prepares a list of the terminal devices that have transmitted the response signals and displays the list through the display unit.

10. The network terminal device as claimed in claim 8, wherein if a specified terminal device is selected on the list, the data transmitting/receiving unit transmits the print data to the selected terminal device.

11. A network system comprising:
a first terminal device for searching for a terminal device connected to a usable printer among other terminal devices connected through a network and transmitting print data to the searched terminal device if a printer installed in the first terminal device is unusable; and
a second terminal device for performing a printing work using the installed printer if the print data is received from the first terminal device.

12. The network system as claimed in claim 11, wherein the first terminal device comprises:
a data transmitting/receiving unit for transmitting and receiving a specified data signal to and from the respective terminal devices connected through the network;
a control unit for searching for other terminal devices connected to usable printers among the respective terminal devices if the printer is unprintable; and
a display unit for displaying a list of the terminal devices connected to the usable printers.

13. The network system as claimed in claim 12, wherein if specified response signals are received from the terminal devices connected to the usable printers after specified search signals are transmitted to the other terminal devices, the control unit prepares a list of the terminal devices that have transmitted the response signals and displays the list through the display unit.

14. The network system as claimed in claim 12, wherein if the second terminal device is selected on the list, the data transmitting/receiving unit transmits the print data to the second terminal device.
